(19) United States
(12) Patent Application Publication
(10) Pub. No.: US 2018/0006306 A1
(43) Pub. Date: Jan. 4, 2018

(54) TRANSITION-METALS DOPED LITHIUM-RICH ANTI-PEROVSKITES FOR CATHODE APPLICATIONS

(71) Applicant: THE BOARD OF REGENTS OF THE NEVADA SYSTEM OF HIGHER EDUCATION on behalf of THE UNIV.OF NEVADA,, Las Vegas, NV (US)

(72) Inventors: Jinlong ZHU, Henderson, NV (US); Shuai LI, Henderson, NV (US); Yusheng ZHAO, Las Vegas, NV (US); John Patrick LEMMON, Washington, DC (US)

(21) Appl. No.: 15/545,000

(22) PCT Filed: Feb. 12, 2016
(86) PCT No.: PCT/US16/17885

§ 371 Date: Jul. 20, 2017

Related U.S. Application Data
(60) Provisional application No. 62/115,521, filed on Feb. 12, 2015.

(51) Int. Cl. H01M 4/58; H01G 9/15; H01G 9/042

(52) U.S. Cl. CPC H01M 4/5825; H01M 4/582; H01G 9/0425; H01G 9/15

(57) ABSTRACT

Transition-metal doped Li-rich anti-perovskite cathode compositions are provided herein. The Li-rich anti-perovskite cathode compositions have a chemical formula of Li_{(3-δ)}M5/ₘBA, wherein 0<δ<3m/(m+1) and δ=3m/(m+1) is the maximum value for the transition metals doping, a chemical formula of Li_{4-δ}Ms_{δ/m}PC₄A, wherein 0<δ≦4m/(m+1) and δ=4m/(m+1) is the maximum value for the transition metals doping, or a combination thereof, wherein M is a transition metal, B is a divalent anion, and A is a monovalent anion. Also provided herein, are methods of making the Li-rich anti-perovskite cathode compositions, and uses of the Li-rich anti-perovskite cathode compositions.

### STATEMENT AS TO FEDERALLY SPONSORED RESEARCH

This invention was made with government support under DE-AR0000347, awarded by the United States Department of Energy. The government has certain rights in the invention.

### FIELD

The disclosure provides transition-metals doped Li-rich anti-perovskite cathode materials (hereinafter “TM-LiRAP-C”) and devices, such as lithium batteries and capacitors that employ the Li-rich anti-perovskite compositions as a cathode. The disclosure also provides synthesis and processing methods of Li-rich anti-perovskite cathode compositions for lithium batteries and capacitors devices.

### BACKGROUND

Batteries with inorganic solid-state electrolytes have many advantages such as enhanced safety, low toxicity, and cycling efficiency. High interfacial resistance and lattice mismatches between the cathode and the solid-state electrolyte have hindered the development of high-performance solid-state batteries for practical applications. The approach of using a continuous compositionally graded lithium-rich anti pervoskite electrode-electrolyte combination can significantly reduce interfacial issues and is a promising approach for next generation vehicle batteries and large-scale energy storage. Currently, several solid electrolyte technologies for lithium batteries have been investigated and thin film based approaches, such as physical deposition of Lithium phosphorous oxy-nitride (hereinafter “LiPON”) based chemistries, have been commercialized. However compared to bulk synthesis and manufacturing techniques, these thin film approaches suffer from low capacity, low power and high cost.

### SUMMARY OF THE INVENTION

Cathode compositions provided herein can include transition-metals doped Li-rich anti-perovskite compositions for cathode applications. In some cases, TM-LiRAP-C materials provided herein have at least 200 mAh/g lithium specific capacities. In some cases, TM-LiRAP-C materials provided herein have at least 300 mAh/g lithium specific capacities, at least 400 mAh/g lithium specific capacities, or at least 500 mAh/g lithium specific capacities. In some cases, TM-LiRAP-C materials provided herein have up to 618 mAh/g lithium specific capacities. TM-LiRAP-C materials have favorable compositional and structural flexibility, which can allow various chemical manipulation techniques. TM-LiRAP-C materials with favorable structure flexibility can be simultaneously interpenetrated with various solid-state electrolytes crystallizing in anti-perovskite, perovskite, spinel, or garnet structures. TM-LiRAP-C materials can have enhanced lithium transport and diffusion rates, which can boost ionic conductivity. TM-LiRAP-C materials can have electronic conductivity or enhanced electronic conductivity by surface decoration or coating (e.g. carbon black, etc) to supply electrical conductivity and charge transfer for energy output. TM-LiRAP-C materials provided herein can be used in rechargeable batteries to produce more affordable rechargeable batteries. TM-LiRAP-C compositions provided herein can be made using any suitable synthesis method and processed into a suitable configuration using any suitable processing method. Certain synthesis methods and processing methods provided herein can achieve high-purity phases with accurately controlled compositions having optimized performance in integrated devices. Certain synthesis methods and processing methods provided herein can be affordable and efficient.

TM-LiRAP-C provided herein meet the specific needs for assembling full solid-state batteries as TM-LiRAP-C∥Li-rich anti-perovskite electrolyte∥Li-Metal Anode that solves solid-solid interface problems. Examples of Li-rich anti-perovskite electrolytes are described in U.S. Pat. No. 9,246,188, which is incorporated by reference in its entirety. The similar crystal structure and lattice parameters minimize the interface mismatch. TM-LiRAP-C and Li-rich anti-perovskite (hereinafter “LiRAP”) materials can be synthesized into well intergrowth layers for full solid-state battery assemblies. The stability and durability of TM-LiRAP-C∥LiRAP electrolyte∥Li-Metal Anode full solid-state batteries benefit from the similar mechanic properties and lithium ion transport mechanisms. The solid-solid interface intergrowth of cathode-electrolyte from solid electrolyte and transition-metal doped cathode is not limited in the case of TM-LiRAP-C and LiRAP electrolyte and can be extended to other solid batteries assembled based on this treatment. For instance, intergrowth of LiFePO₄ and Li₃PO₄, and intergrowth of LiFePO₄ and LiPON are non-limiting examples.

Cathode compositions provided herein can include TM-LiRAP-C having a formula of Li_{(3-δ)}M_{δ/2}OA, Li_{(3-δ)}M_{δ/2}SA, Li_{(3-δ)}M_{δ/2}SO₄A (0<δ≦2) and/or Li_{(4-δ)}M_{δ/2}PO₄A (0<δ≦2.67); Li_{(3-δ)}M_{δ/3}OA, Li_{(3-δ)}M_{δ/3}SA, Li_{(3-δ)}M_{δ/3}SO₄A (0<δ≦2.25) and/or Li_{(4-δ)}M_{δ/3}PO₄A (0<δ≦3); Li_{(3-δ)}M_{δ/4}OA, Li_{(3-δ)}M_{δ/4}SA, Li_{(3-δ)}M_{δ/4}SO₄A (0<δ≦2.4) and/or Li_{(4-δ)}M_{δ/4}PO₄A (0<δ≦3.2); Li_{(3-δ)}M_{δ/5}OA, Li_{(3-δ)}M_{δ/5}SA, Li_{(3-δ)}M_{δ/5}SO₄A (0<δ≦2.5) and/or Li_{(4-δ)}M_{δ/5}PO₄A (0<δ≦3.33); Li_{(3-δ)}M_{δ/6}OA, Li_{(3-δ)}M_{δ/6}SA, Li_{(3-δ)}M_{δ/6}SO₄A (0<δ≦2.57) and/or Li_{(4-δ)}M_{δ/6}PO₄A (0<δ≦3.43), wherein A is selected from F⁻, Cl⁻, Br⁻, I⁻, H⁻, CN⁻, BF₄⁻, BH₄⁻, ClO₄⁻, CH₃⁻, NO₂⁻, NH₂⁻ and mixtures thereof, and wherein M is a metal with alterable higher oxidation state selected from the group consisting of iron, cobalt, nickel, manganese, titanium, vanadium, chromium, molybdenum, and mixtures thereof.

TM-LiRAP-C provided herein have a chemical formula of Li_{(3-δ)}M_{δ/m}BA, wherein 0<δ≦3m/(m+1); δ=3m/(m+1) is the maximum value for the transition metals doping, wherein m+ is the valence of the transition metal and the transition metals have the capability of change from m+ valence to (m+1)+ valence. TM-LiRAP-C provided herein have a chemical formula of Li_{(4-δ)}M_{δ/m}PO₄A, wherein 0<δ≦4m/(m+1); δ=4m/(m+1) is the maximum value for the transition metals doping, wherein m+ is the valence of the transition metal and the transition metals have the capability of change from m+ valence to (m+1)+ valence. For example, LiFeOBr has a Fe²⁺ doping with δ=3m/(m+1)=3×2/(2+1)=2; Li_{0.8}Mn_{0.8}PO₄I has a Mn⁴⁺ doping with δ=4m/(m+1)=4×4/(4+1)=3.2. For multi-valent changing while TM-LiRAP-C working as cathode in a lithium battery, the optimized doping amount of transition metals is covered in the formula of Li_{(3-δ)}M_{δ/m}BA, wherein 0<δ≦3m/(m+1), and Li_{(4-δ)}M_{δ/m}PO₄A, wherein 0<δ≦4m/(m+1). For example, Li_{1.5}Co_{0.75}OBr has a δ=1.5 in Li_{(3-δ)}Co_{δ/2}OBr, and all the Li⁺ can be deintercalated while Co²⁺ being oxidized to Co⁴⁺; Li_{2.4}Mn_{0.8}PO₄I has a δ=1.6 in Li_{(4-δ})Mn_{δ/2}PO₄I, and all the Li⁺ can be deintercalated while Mn²⁺ being oxidized to Mn⁵⁺.

Electrochemical devices provided herein can include transition-metals doped Li-rich anti-perovskite compositions having a formula of Li_{(3-δ)}M_{δ/2}OA, Li_{(3-δ)}M_{δ/2}SA, Li_{(3-δ)}M_{δ/2}SO₄A (0<δ≦2) and/or Li_{(4-δ)}M_{δ/2}PO₄A (0<δ≦2.67); Li_{(3-δ)}M_{δ/3}OA, Li_{(3-δ)}M_{δ/3}SA, Li_{(3-δ)}M_{δ/3}SO₄A (0<δ≦2.25) and/or Li_{(4-δ)}M_{δ/3}PO₄A (0<δ≦3); Li_{(3-δ)}M_{δ/4}OA, Li_{(3-δ)}M_{δ/4}SA, Li_{(3-δ)}M_{δ/4}SO₄A (0<δ≦2.4) and/or Li_{(4-δ)}M_{δ/4}PO₄A (0<δ≦3.2); Li_{(3-δ)}M_{δ/5}OA, Li_{(3-δ)}M_{δ/5}SA, Li_{(3-δ)}M_{δ/5}SO₄A (0<δ≦2.5) and/or Li_{(4-δ)}M_{δ/5}PO₄A (0<δ≦3.33); Li_{(3-δ)}M_{δ/6}OA, Li_{(3-δ)}M_{δ/6}SA, Li_{(3-δ)}M_{δ/6}SO₄A (0<δ≦2.57) and/or Li_{(4-δ)}M_{δ/6}PO₄A (0<δ≦3.43), wherein A is selected from F⁻, Cl⁻, Br⁻, I⁻, H⁻, CN⁻, BF₄⁻, BH₄⁻, ClO₄⁻, CH₃⁻, NO₂⁻, NH₂⁻ and mixtures thereof, and wherein M is a metal with alterable higher oxidation state selected from the group consisting of iron, cobalt, nickel, manganese, titanium, vanadium, chromium, molybdenum, and mixtures thereof.

Capacity compositions provided herein can include transition-metals doped Li-rich anti-perovskite compositions having a formula of Li_{(3-δ)}M_{δ/2}OA, Li_{(3-δ)}M_{δ/2}SA, Li_{(3-δ)}M_{δ/2}SO₄A (0<δ≦2) and/or Li_{(4-δ)}M_{δ/2}PO₄A (0<δ≦2.67); Li_{(3-δ)}M_{δ/3}OA, Li_{(3-δ)}M_{δ/3}SA, Li_{(3-δ)}M_{δ/3}SO₄A (0<δ≦2.25) and/or Li_{(4-δ)}M_{δ/3}PO₄A (0<δ≦3); Li_{(3-δ)}M_{δ/4}OA, Li_{(3-δ)}M_{δ/4}SA, Li_{(3-δ)}M_{δ/4}SO₄A (0<δ≦2.4) and/or Li_{(4-δ)}M_{δ/4}PO₄A (0<δ≦3.2); Li_{(3-δ)}M_{δ/5}OA, Li_{(3-δ)}M_{δ/5}SA, Li_{(3-δ)}M_{δ/5}SO₄A (0<δ≦2.5) and/or Li_{(4-δ)}M_{δ/5}PO₄A (0<δ≦3.33); Li_{(3-δ)}M_{δ/6}OA, Li_{(3-δ)}M_{δ/6}SA, Li_{(3-δ)}M_{δ/6}SO₄A (0<δ≦2.57) and/or Li_{(4-δ)}M_{δ/6}PO₄A (0<δ≦3.43), wherein A is selected from F⁻, Cl⁻, Br⁻, I⁻, H⁻, CN⁻, BF₄⁻, BH₄⁻, ClO₄⁻, CH₃⁻, NO₂⁻, NH₂⁻ and mixtures thereof, and wherein M is a metal with alterable higher oxidation state selected from the group consisting of iron, cobalt, nickel, manganese, titanium, vanadium, chromium, molybdenum, and mixtures thereof.

Synthesis and processing methods provided herein can result in transition-metals doped Li-rich anti-perovskite compositions in the form of fine powders, single crystals and films.

It should be understood that a device according to the present disclosure can include the disclosed compositions in any number of forms, e.g., as a film, as a single crystal slice, as a trace, or as another suitable structure. The disclosed materials can be disposed (e.g., via spin coating, pulsed laser deposition, lithography, or other deposition methods known to those of ordinary skill in the art) to a substrate or other part of a device. Masking, stencils, and other physical or chemical deposition techniques can be used so as to give rise to a structure having a particular shape or configuration.

In some cases, TM-LiRAP-C compositions provided herein can be in the form of a film. In some cases, a thickness of a film of anti-perovskite cathode provided herein can be between about 0.1 micrometers to about 1000 micrometers. In some cases, a thickness of a film of anti-perovskite cathode provided herein can have a thickness of about 10 micrometers to about 20 micrometers. In some cases, film and non-film structures comprising anti-perovskite cathode compositions provided herein can have thicknesses of between 0.1 micrometers to about 1000 micrometers, between 1 micrometer and 100 micrometers, between 5 micrometers and 50 micrometers, or between 10 micrometers and 20 micrometers. For example, a device (e.g., a battery) provided herein can include an anode, an electrolyte, and a cathode film having a thickness of between about 10 micrometers and about 20 micrometers. In some cases, a device provided herein can include a protective layer. In some cases, a protective layer on a device provided herein can be used to shield or otherwise protect components of the device, including the cathode. For example, suitable protective layers can include insulating substrates, semiconducting substrates, and even conductive substrates. Protective layers on devices provided herein can include any suitable material, such as SiO₂.

### BRIEF DESCRIPTION OF THE FIGURE DRAWINGS

The summary, as well as the following detailed description, is further understood when read in conjunction with the appended drawings. For the purpose of illustrating the disclosed invention, drawings of exemplary embodiments are shown. Nonetheless, the disclosure is not limited to the specific methods, compositions, and devices disclosed herein. In addition, the drawings are not necessarily drawn to scale or proportion. Furthermore, this patent or patent application file contains at least one drawing executed in color. Copies of this patent or patent application publication with color drawings will be provided by the Office upon request with payment of the necessary fee.

FIG. 1 depicts an exemplary anti-perovskite structure drawing of Li_{(3-δ)}M_{δ/m}BA and/or Li_{(4-δ)}M_{δ/m}PO₄A(M=Fe²⁺, Fe³⁺, Fe⁴⁺, Co²⁺, Co³⁺, Ni²⁺, Ni³⁺, Mn²⁺, Mn³⁺, Mn⁴⁺, Mn⁵⁺, Mn⁶⁺, Ti²⁺, Ti³⁺, V²⁺, V³⁺, V⁴⁺, Cr²⁺, Cr³⁺, Cr⁴⁺, Cr⁵⁺, Mo³⁺, Mo⁴⁺, Mo⁵⁺, etc; B═O²⁻, S²⁻, SO₄²⁻, etc; A=F⁻, Cl⁻, Br⁻, I⁻, H⁻, CN⁻, BF₄⁻, BH₄⁻, ClO₄⁻, CH₃⁻, NO₂⁻, NH₂⁻, etc; m=the value of the M valence) to illustrate the 3-dimensional geometry of Li⁺. The [BLi₆] or [PO₄Li₆] octahedron is the basic building unit of an anti-perovskite structure.

FIG. 2 depicts powder XRD patterns of different transition-metal doped LiRAP embodiments, such as cobalt, chromium, nickel, iron at Li site; the A site can be pure Br⁻ ion or a mixture of Br⁻ and Cl⁻ or can be a small molecular group NO₂⁻. For an iron doped sample, it is a mixture of cubic (Fm-3m) and tetragonal layered structure (I4/mmm), and for the rest of samples, they crystallize into a cubic (Fm-3m) anti-perovskite structure.

FIG. 3 depicts cyclic voltammetry (CV) curves of exemplary embodiments in batteries of Li_{1.5}Ni_{0.75}OBr_{0.5}Cl_{0.5}∥Li₃OBr_{0.5}Cl_{0.5}∥Li-Metal, Li_{2.4}Co_{0.3}OBr∥LiPF₆+EC+DMC∥Li-Metal and (Li₂Fe_{0.5}OBr)₂Li₅FeO₂Br₃∥LiPF₆+EC+DMC∥Li-Metal. The CV curves show that the Li-rich anti-perovskite cathode compositions have a wide electrochemical working window from 0 V to greater than 4 V, and are stable while cycling up to 10 times. The oxidation/reduction peaks of lithium and the TM-LiRAP-C compositions are marked accordingly.

FIG. 4 depicts charging/discharging cycles of an exemplary embodiment in a full battery of Li_{(3-δ)}Co_{δ/2}OBr∥LiPF₆+EC+DMC∥Li-Metal (left) and the columbic efficiency for the liquid electrolyte battery (right). The cycling temperature is 25° C.

FIG. 5 depicts charging/discharging cycles of an exemplary embodiment in a full battery of Li_{(3-δ)}Ni_{δ/2}ONO₂∥LiPF₆+EC+DMC∥Li-Metal (left) and the columbic efficiency for the liquid electrolyte battery (right). The low columbic efficiencies of first several cycles for Li_{(3-δ)}Ni_{δ/2}ONO₂∥LiPF₆+EC+DMC∥Li-Metal are due to the shorter discharging time compared with charging time. The cycling temperature is 25° C.

FIG. 6 depicts charging/discharging cycles of an exemplary embodiment in a full battery of Li_{(3-δ)}Ni_{δ/2}OBr_{0.5}Cl_{0.5}∥LiRAP∥Li-Metal (left) and voltage and current profile vs. time (right). The cycling temperature is 90° C.

FIG. 7 depicts Arrhenius plots of log(σ) versus 1/T for Li_{2.4}Co_{0.3}OBr, Li_{1.6}Cr_{0.7}OBr, Li_{1.5}Ni_{0.75}OBr_{0.5}Cl_{0.5}, Li₂FeOBr—Li₅FeO₂Br and LiNiONO₂ anti-perovskites embodiments. The activation energies Eₐ are derived by the slopes of the linear fitting of: ln(σ)=−Eₐ/kT. The compound activation energies lie between 0.4 eV to 0.7 eV.

FIG. 8 depicts differential scanning calorimetry (DSC) analysis of a Li_{2.4}Co_{0.3}OBr embodiment collected at a heating rate of 10 K min⁻¹ in a flow of dry argon gas.

FIG. 9 depicts scanning electron microscopy (SEM) images of a cross-section of solid state battery TM-LiRAP-C∥LiRAP∥Li-metal embodiment fabricated via hot press method.

FIG. 10 depicts charging/discharging curves (left) and capacity change (right) of a solid state battery embodiment with a co-synthesized bi-layer Co-doped Li₃OBr and Li₃OBr, and Li-metal anode. The data is collected at 90° C.

### DETAILED DESCRIPTION

The present disclosure is not limited in its application to the specific details of construction, arrangement of components, or method steps set forth herein. The methods disclosed herein are capable of being practiced, used and/or carried out in various ways. The phraseology and terminology used herein is for the purpose of description only and should not be regarded as limiting. Ordinal indicators, such as first, second, and third, as used in the description and the claims to refer to various structures, are not meant to be construed to indicate any specific structures, or any particular order or configuration to such structures or steps. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification, and no structures shown in the drawings, should be construed as indicating that any non-claimed element is essential to the practice of the invention. The use herein of the terms “including,” “comprising,” or “having,” and variations thereof, is meant to encompass the items listed thereafter and equivalents thereof, as well as additional items.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application. Use of the word “about” to describe a particular recited amount or range of amounts is meant to indicate that values very near to the recited amount are included in that amount, such as values that could or naturally would be accounted for due to manufacturing tolerances, instrument and human error in forming measurements, and the like.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinency of any of the documents cited herein. All references cited herein are fully incorporated by reference, unless explicitly indicated otherwise. The present disclosure shall control in the event there are any disparities. No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinency of any of the documents cited herein. All references cited herein are fully incorporated by reference, unless explicitly indicated otherwise. The present disclosure shall control in the event there are any disparities.

Transition-metals doped Li-rich anti-perovskite compositions provided herein can be used in a variety of devices (e.g., batteries). In some cases, lithium batteries can include a TM-LiRAP-C composition provided herein, which can provide good lattice matches between cathodes and correspondingly Li-rich anti-perovskite electrolytes, compared to interfaces between different structural solid electrolytes and cathode compositions, as the intergrowth of these two similar crystal structures. In some cases, Li-rich anti-perovskite compositions provided herein include a material having a formula of Li_{(3-δ)}Co_{δ/2}OBr. In some cases, Li-rich anti-perovskite compositions provided herein can include one or more materials having a general formula of Li_{(3-δ)}M_{δ/m}BA and/or Li_{(4-δ)}M_{δ/m}PO₄A, wherein A is a monovalent anion selected from the group consisting of fluoride, chloride, bromide, iodide, H⁻, CN⁻, BF₄⁻, BH₄⁻, ClO₄⁻, CH₃⁻, NO₂⁻, NH₂⁻ and a mixture thereof, M is a metal with alterable higher oxidation states selected from the group consisting of Fe²⁺, Fe³⁺, Fe⁴⁺, Co²⁺, Co³⁺, Ni²⁺, Ni³⁺, Mn²⁺, Mn³⁺, Mn⁴⁺, Mn⁵⁺, Mn⁶⁺, Ti²⁺, Ti³⁺, V²⁺, V³⁺, V⁴⁺, Cr²⁺, Cr³⁺, Cr⁴⁺, Cr⁵⁺, Mo³⁺, Mo⁴⁺, Mo⁵⁺, and a mixture thereof, and B is bivalent anion selected from O²⁻, S²⁻, SO₄²⁻, while m equals to the value of the M valence). The value of δ in the formula of Li_{(3-δ)}M_{δ/m}BA is 0<δ≦2.57 and in the formula of Li_{(4-δ)}M_{δ/m}PO₄A is 0<δ≦3.43. For example δ can be, but is not limited to, 0.10, 0.15, 0.20, 0.25, 0.30, 0.35, 0.40, 0.45, 0.50, 0.55, 0.60, 0.65, 0.70, 0.75, 0.80, 0.85, 0.90, 0.95, 1.00, 1.05, 1.10, 1.15, 1.20, 1.25, 1.30, 1.35, 140, 1.45, 1.50, 1.55, 1.60, 1.65, 1.70, 1.75, 1.80, 1.85, 1.90, 1.95, 2.00, 2.05, 2.10, 2.15, 2.20, 2.25, 2.30, 2.35, 2.40, 2.45, 2.50, 2.55, 2.60, 2.65, 2.70, 2.75, 2.80, 2.85, 2.90, 2.95, 3.00, 3.05, 3.10, 3.15, 3.20, 3.25, 3.30, 3.35, 3.40, or 3.43.8 can have a value smaller than 0.10 and larger than 3.43. For example, δ can be 0.01, 0.02, 0.03, 0.04, 0.05, 0.06, 0.07, 0.08 or 0.09. For each of these values of δ, A is a halide or monovalent anion (e.g., H⁻, CN⁻, BF₄⁻, BH₄⁻, ClO₄⁻, CH₃⁻, NO₂⁻, NH₂⁻, etc), or a mixture thereof, and M is a cationic metal with alterable higher oxidation states, or a mixture of cationic metals with alterable higher oxidation states. It should be understood that M can be a mixture of any two alterable oxidation state metals, any three alterable oxidation state metals, or any four alterable oxidation state metals.

A can be a mixture of halides, a mixture of monovalent anions, or a mixture thereof. A can be a mixture of chloride and bromide. A can be a mixture of chloride and fluoride. A can be a mixture of chloride and iodide. A can be a mixture of BF₄⁻ and a halide. A can be a mixture of chloride, bromide and iodide. It should be understood that A can be a mixture of any two halides, any three halides, or any four four halides. A can also be a mixture of monovalent anions (e.g., H⁻, CN⁻, BF₄⁻, BH₄⁻, ClO₄⁻, CH₃⁻, NO₂⁻, NH₂⁻).

TM-LiRAP-C compositions provided herein are either of anti-perovskite structures or anti-perovskite-related structures. An explanation of what is meant by an anti-perovskite can be better understood in relation to what a normal perovskite is. A normal perovskite has a composition of the formula ABO₃ wherein A is a cation Aⁿ⁺, B is a cation B⁽⁶⁻ⁿ⁾⁺ and O is oxygen anion O²⁻. Examples include K⁺Nb⁵⁺O₃, Ca²⁺Ti⁴⁺O₃, La³⁺Fe³⁺O₃. A normal perovskite is also a composition of the formula ABX₃, wherein A is a cation A⁺, B is a cation B²⁺ and X is an anion X⁻. Examples are K⁺Mg²⁺F₃ and Na⁺Mg²⁺F₃. A normal perovskite has a perovskite-type crystal structure, which is a well-known crystal structure within the art, having a dodecahedral center that is regularly referred to as A-site and an octahedral center that is regularly referred as B-site.

In contrast to a normal perovskite, an anti-perovskite composition also has the formula ABX₃, but A and B are anions and X is the cation. For example, the anti-perovskite ABX₃ having the chemical formula BrOLi₃ has a perovskite crystal structure but the A (e.g. Br⁻) is an anion, the B (e.g. O²⁻) is an anion, and X (e.g. Li⁺) is a cation. Following the “cation-first” convention in the usual inorganic nomenclature of ionic compounds, we henceforth reverse the suggestive notation A⁻B²⁻X⁺₃ to the anti-perovskite notation defined as: X⁺₃B²⁻A⁻; e.g. Li₃OBr, here X is lithium, B is oxygen, and A is bromine. Thus, the transition-metals doped Li-rich anti-perovskite cathode is denoted as Li_{(3-δ)}Co_{δ/2}OBr, which is an example of an anti-perovskite cathode composition provided herein.

TM-LiRAP-C compositions provided herein can have a general formula of Li_{(4-δ)}M_{δ/m}PO₄A, wherein 0<δ≦3.43 and m equals to the value of the M valence. In some specific case, the compounds have a stoichiometric anti-perovskite formula of X₃BA, when δ=m/(m−1). For examples, when m=2, 3, 4, 5, 6, and δ=2, 1.5, 4/3, 1.25, 1.3, respectively, Li₂FePO₄A, Li_{2.5}Ni_{0.5}PO₄A, Li_{8/3}V_{4/3}PO₄A, Li_{2.75}Mn_{0.25}PO₄A and Li_{2.8}Mn_{0.2}PO₄A all have a stoichiometric X₃BA formula. Similarly, when PO₄³⁻ mixing with O²⁻, S²⁻ or SO₄²⁻ anions, and adjusting the doping ratio of various transition metals, the formula can keep a stoichiometric X₃BA. Accordingly, by altering the different valence transition metals and anions, doping with a stoichiometric formula can effectively tune the electron and Li⁺ ion conductivities, energy density, as well as power density.

TM-LiRAP-C provided herein with a formula of Li_{(3-δ)}M_{δ/m}BA has a theoretical capacity n×(δ/m)×F/(3.6×MW) when (0<δ≦3×m/(m+n)), and a maximum theoretical capacity when (δ=3×m/(m+n)); with a formula of Li_{(4-δ)}M_{δ/m}PO₄A has a theoretical capacity as n×(δ/m)×F/(3.6×MW) when (0<δ≦4×m/(m+n)), and a maximum theoretical capacity when (δ=4×m/(m+n)), wherein transition metals change valence between m⁺ and (m+n)⁺ (M=Fe²⁺, Fe³⁺, Fe⁴⁺, Co²⁺, Co³⁺, Ni²⁺, Ni³⁺, Mn²⁺, Mn³⁺, Mn⁴⁺, Mn⁵⁺, Mn⁶⁺, Ti²⁺, Ti³⁺, V²⁺, V³⁺, V⁴⁺, Cr²⁺, Cr³⁺, Cr⁴⁺, Cr⁵⁺, Mo³⁺, Mo⁴⁺, Mo⁵⁺, etc and a mixture thereof; B═O²⁻, S²⁻, SO₄²⁻, etc and a mixture thereof; A=F⁻, Cl⁻, Br⁻, I⁻, H⁻, CN⁻, BF₄⁻, BH₄⁻, ClO₄⁻, CH₃⁻, NO₂⁻, NH₂⁻, etc and a mixture thereof; m=the value of the M valence, n=the value of M valence change, MW=the molecular weight of the composite, F=Faraday constant 96485 C/mol). For example, LiFeSO₄Br has δ=2, m=2, n=1, MW=238.75 in Li_{(3-δ)}Fe_{δ/2}SO₄Br, and the theoretical capacity is 1×1×96485/(3.6×238.75)=112.26 mAh/g with all the Li⁺ being deintercalated while Fe²⁺ being oxidized to Fe³⁺. Li_{1.5}Co_{0.75}OF has δ=1.5, m=2, n=2, MW=89.609 in Li_{(3-δ)}Co_{δ/2}OF, and the theoretical capacity is 2×0.75×96485/(3.6×89.609)=448.64 mAh/g with all the Li⁺ being deintercalated while Co²⁺ being oxidized to Co⁴⁺. Li_{1.8}V_{0.6}ONH₂ has δ=1.2, m=2, n=3, MW=75.081 in Li_{(3-δ)}V_{δ/2}ONH₂, and the theoretical capacity is 3×0.6×96485/(3.6×75.081)=642.54 mAh/g with all the Li⁺ being deintercalated while V²⁺ being oxidized to V⁵⁺. Li_{2.4}Mn_{0.8}PO₄I has δ=1.6, m=2, n=3, MW=282.485 in Li_{(3-δ)}V_{δ/2}PO₄I, and the theoretical capacity is 3×0.8×96485/(3.6×282.485)=227.71 mAh/g with all the Li⁺ being deintercalated while Mn²⁺ being oxidized to Mn⁵⁺.

The statement “Li-rich” denotes the high molar ratio of lithium up to 60% in the anti-perovskite structure, and the 3-dimensional conducting paths generated from this structure feature. Generally, the transition-metals doped Li-rich anti-perovskite cathode compositions are not limited in the case of a single atomic ion in the A or B sites. When a small molecule group such as BF₄⁻ occupies the A/B site, the product Li_{(3-δ)}Co_{δ/2}O(BF₄) is still Li-rich antiperovskite; or PO₄³⁻ occupies the A/B site, the product Li_{(4-δ)}Co_{δ/2}PO₄(BF₄) is still Li-rich antiperovskite. Besides, the “Li-rich” concept should not be limited by an appointed weight percent.

Both Li_{(3-δ)}Co_{δ/2}OBr and Li_{(3-δ)}Co_{(δ/2-y)}Ni_{2y/3}OBr are antiperovskites embodiments. The latter can be thought of relative to the former as having some of the sites that would have been occupied with Co²⁺ now being replaced with the higher valence cation Ni³⁺. This replacement introduces more vacancies in the anti-perovskite crystal lattice, relative to Co²⁺ alone. Without being bound to any particular theory, it is believed that replacement of 2 Li⁺ with a Co²⁺ introduces a vacancy and that replacement of 3 Li⁺ with a Ni³⁺ introduces two vacancies in the antiperovskite crystal lattice. It is believed that the creation of additional vacancies by replacing three lithium cations with a nickel cation maintains the charge balance, and is responsible for an improved ionic conductivity of Li_{2.1}Co_{0.3}Ni_{0.1}OBr relative to Li_{2.4}Co_{0.3}OBr. It is believed that these vacancies facilitate Li⁺ hopping in the lattice. For example, CV tests show that there are two oxidation and reduction peaks corresponding to the Co cation and the Ni cation for Li_{2.1}Co_{0.3}Ni_{0.1}OBr. Battery charging/discharging shows that Li_{2.1}Co_{0.3}Ni_{0.1}OBr has a higher specific energy density as compared to Li_{2.4}Co_{0.3}OBr. It is believed Ni³⁺/Ni⁴⁺ oxidation and reduction provides more lithium source as a cathode.

TM-LiRAP-C compositions provided herein have both Li⁺ conductivity and electronic conductivity. Depending on the doped level and type of doped transition-metals, the electronic conductivity ranges from 10⁻⁴ S/cm to 10⁻⁸ S/cm, such as 10⁻⁵ S/cm in Li_{2.4}Co_{0.3}OBr compounds. For relatively low electronic conductivity TM-LiRAP-C, inactive conductive diluents can be added to enhance the electronic conductivity (such as carbon black) in the purpose of easy addition or removal of electrons during the electrochemical reaction during a battery charging and discharging.

In some cases, TM-LiRAP-C compositions provided herein have a formula of Li_{(3-δ)}M_{δ/2}OA, Li_{(3-δ)}M_{δ/2}SA, Li_{(3-δ)}M_{δ/2}SO₄A (0<δ≦2) and/or Li_{(4-δ)}M_{δ/2}PO₄A (0<δ≦2.67), wherein A is a halide (e.g., F⁻, Cl⁻, Br⁻, I⁻ and mixtures thereof) or other monovalent anions (e.g., H⁻, CN⁻, BF₄⁻, BH₄⁻, ClO₄⁻, CH₃⁻, NO₂⁻, NH₂⁻, etc), and mixtures thereof, and wherein M is divalent cation M⁺² with alterable higher oxidation states (e.g., Fe²⁺, Co²⁺, Ni²⁺, Mn²⁺,Ti²⁺, V²⁺, Cr²⁺ and mixtures thereof). TM-LiRAP-C compositions provided herein can have a chemical formula of Li_{(3-δ)}M_{δ/3}OA, Li_{(3-δ)}M_{δ/3}SA, Li_{(3-δ)}M_{δ/3}SO₄A (0<δ≦2.25) and/or Li_{(4-δ)}M_{δ/3}PO₄A (0≦δ≦3), wherein A is a halide (e.g., F⁻, Cl⁻, Br⁻, I⁻ and mixtures thereof) or other monovalent anions (e.g., H⁻, CN⁻, BF₄⁻, BH₄⁻, ClO₄⁻, CH₃⁻, NO₂⁻, NH₂⁻, etc), and mixtures thereof, and wherein M is trivalent cation M⁺³ with alterable higher oxidation states (e.g., Fe³⁺, Co³⁺, Ni³⁺, Mn³⁺, Ti³⁺, V³⁺, Cr³⁺, Mo³⁺ and mixtures thereof). TM-LiRAP-C compositions provided herein can have a chemical formula of Li_{(3-δ)}M_{δ/4}OA, Li_{(3-δ)}M_{δ/4}SA, Li_{(3-δ)}M_{δ/4}SO₄A (0<δ≦2.4) and/or Li_{(4-δ)}M_{δ/4}PO₄A (0<δ≦3.2), wherein A is a halide (e.g., F⁻, Cl⁻, Br⁻, I⁻ and mixtures thereof) or other monovalent anions (e.g., H⁻, CN⁻, BF₄⁻, BH₄⁻, ClO₄⁻, CH₃⁻, NO₂⁻, NH₂⁻, etc), and mixtures thereof, and wherein M is tetravalent cation M⁺⁴ with alterable higher oxidation states (e.g., Fe⁴⁺, Mn⁴⁺, V⁴⁺, Cr⁴⁺, Mo⁴⁺ and mixtures thereof). TM-LiRAP-C compositions provided herein can have a chemical formula of Li_{(3-δ)}M_{δ/5}OA, Li_{(3-δ)}M_{δ/5}SA, Li_{(3-δ)}M_{δ/5}SO₄A (0<δ≦2.5) and/or Li_{(4-δ)}M_{δ/5}PO₄A (0<δ≦3.33), wherein A is a halide (F⁻, Cl⁻, Br⁻, I⁻ and mixtures thereof) or other monovalent anions (e.g., H⁻, CN⁻, BF₄⁻, BH₄⁻, ClO₄⁻, CH₃⁻, NO₂⁻, NH₂⁻, etc), and mixtures thereof, and wherein M is pentavalent cation M⁺⁵ with alterable higher oxidation states (e.g., Mn⁵⁺, Cr⁵⁺, Mo⁵⁺ and mixtures thereof). TM-LiRAP-C compositions provided herein can have a chemical formula of Li_{(3-δ)}M_{δ/6}OA, Li_{(3-δ)}M_{δ/6}SA, Li_{(3-δ)}M_{δ/6}SO₄A (0<δ≦2.57) and/or Li_{(4-δ)}M_{δ/6}PO₄A (0<δ≦3.43), wherein A is a halide (e.g., F⁻, Cl⁻, Br⁻, I⁻ and mixtures thereof) or other monovalent anions (e.g., H⁻, CN⁻, BF₄⁻, BH₄⁻, ClO₄⁻, CH₃⁻, NO₂⁻, NH₂⁻, etc), and mixtures thereof, and wherein M is sexivalent cation M⁺⁶ with alterable higher oxidation states (e.g., Mn⁶⁺).

It should be mentioned that, TM-LiRAP-C compositions provided herein are not limited to typical cubic perovskite structure, but can also be other perovskite-related structures. For example, distorted perovskite structures with low symmetries, structures comprising of anion centered XLi₆ octahedra units, are possible perovskite-related structures that Li-rich anti-perovskite cathode compositions can adopt. TM-LiRAP-C provided herein have the crystal structure of cubic anti-perovskite, distorted antiperovskite with triclinic, rhombohedral, orthorhombic and tetragonal structures having the formula of X₃BA where A and B are anions and X is the cation. TM-LiRAP-C provided herein can also have a defected formula with layered structures. For examples, X₄BA₂, X₅B₂A₃, X₇B₂A₃ can all be anti-perovskite, and TM-LiRAP-C provided herein are not limited to the specific formula listed herein.

It should be mentioned that, TM-LiRAP-C compositions Li_{(3-δ)}M_{δ/m}BA and/or Li_{(4-δ)}M_{δ/m}PO₄A stated here are not limited to O²⁻, S²⁻, SO₄²⁻, or PO₄³⁻ anions exactly located in the B-sites and monovalent anions, such as F⁻, Cl⁻, Br⁻, I⁻, H⁻, CN⁻, BF₄⁻, BH₄⁻, ClO₄⁻, CH₃⁻, NO₂⁻ or NH₂⁻, in the A-sites. Both of the mono-, di- and tri-valent anions can occupy either A-sites or B-sites, or have a mixed distribution between them. This situation can happen when the ionic radiuses of the two anions are very close (r(S²⁻)=1.84 angstrom versus r(Cl⁻)=1.81 angstrom. For example, both Li_{2.4}Co_{0.3}OBr and Li_{2.4}Co_{0.3}BrO are Li-rich anti-perovskites electrode compositions provided herein. No matter which anion is situated at the A-site and/or at the B-site, they still have an anti-perovskite structure.

Transition-metals doped Li-rich anti-perovskite compositions provided herein can be used as a cathode in lithium ionic batteries, capacitors and other electrochemical devices. These Li-rich anti-perovskites provide advantages such as good contact interface, high stability, high safety and no leakage over more conventional gel-liquid systems. These crystalline solids can, in some cases, provide better machinability, lower cost and decreased inflammability.

TM-LiRAP-C can be prepared by using a direct solid state reaction method, lithium metal reduction method, solution precursor method or organic halides halogenations method. Li-rich anti-perovskite cathode films can be processed by a melting-and-coating method or a vacuum splashing method.

TM-LiRAP-C can be prepared by using a direct solid state reaction method. In an embodiment, Li₂O, LiBr and CoO (0.7:1.0:0.3 molar ratio) are mixed thoroughly in a glove box. Annealing at 300-500° C. followed by repeated grinding and heating several times provide the anti-perovskite cathode products Li_{2.4}Co_{0.3}OBr. In another example, anhydrous Li₃PO₄ and NiBr₂ (1:0.5 molar ratio) are mixed thoroughly in a glove box. Annealing at 300-500° C. followed by repeated grinding and heating several times provide the anti-perovskite cathode products Li₃Ni_{0.5}PO₄Br.

TM-LiRAP-C can be prepared by using a lithium metal reduction method. In another embodiment, LiOH, Co(OH)₂ and LiBr (0.4:0.3:1 molar ratio) are mixed thoroughly in air, then excessive Li metal (110% molar ratio) is added in the mixture in a glove box. Slow heating to 300° C. under vacuum and annealing at 300-500° C. followed by repeated grinding and heating several times provide the anti-perovskite cathode products Li_{2.4}Co_{0.3}OBr.

TM-LiRAP-C cathodes can be prepared by using a LiH reduction method. In another embodiment, LiOH, Co(OH)₂ and LiBr (0.4:0.3:1 molar ratio) are mixed thoroughly in air, then LiH (100% molar ratio) is added in the mixture in a glove box. Slow heating to 300° C. under vacuum and annealing at 300-500° C. followed by repeated grinding and heating several times provide the anti-perovskite cathode products Li_{2.4}Co_{0.3}OBr.

TM-LiRAP-C can be prepared by using a solution precursor method. In another embodiment, LiOH, Co(OH)₂ and LiBr (0.4:0.3:1 molar ratio) solutions are mixed together in air. After slow heating at 60, 80, 100, 150 and 200° C., excessive Li metal (110% molar ratio) is added in the mixture in a glove box. Slow heating to 300° C. under vacuum and annealing at 300-500° C. followed by repeated grinding and heating several times provide the anti-perovskite cathode products Li_{2.4}Co_{0.3}OBr.

TM-LiRAP-C can be prepared in a thin film platform by using solution precursor method. In another embodiment, LiOH, Co(OH)₂ and LiCl (0.4:0.3:1 molar ratio) solutions are mixed together and concentrated in air. Then it is dipped or spread on various substrates including Al₂O₃, Al foil, Pt foil and Au foil. After slow heating at 60, 80, 100, 150 and 200° C., Li metal is splashed to the surface at moderated temperature. Slow heating to 300° C. under vacuum and annealing at 300-500° C. provide the anti-perovskite cathode films.

In a vacuum sputtering process and in a paused laser deposition (PLD) process, both the mixture of the raw reagents (Li₂O+MO_{m/2}+LiA) and/or already-formed anti-perovskites (Li_{(3-δ)}M_{δ/m}BA) can be used as starting materials. The final products are Li_{(3-δ)}M_{δ/m}BA with anti-perovskite structure.

Various solvents can be used to provide TM-LiRAP-C compositions, including toluene, methanol, ethanol, CCl₄, and mixtures thereof. In a preferred embodiment, toluene is used as the solvent.

High pressure techniques can be used to obtain some phases such as Li_{(3-δ)}M_{δ/m}O(NH₂), Li_{(3-δ)}M_{δ/m}O(BH₄), Li_{(3-δ)}M_{δ/m}SCl and Li_{(3-δ)}M_{δ/m}S(NO₂). The syntheses is monitored by in-situ and real-time synchrotron X-ray diffraction using a large volume PE cell at Beamline 16-BMB and/or 13-IDC of the Advanced Photon Source (APS) at Argonne National Laboratory. The pressure and temperature ranges are 1-7 GPa and 100-1500° C., respectively.

The EXAMPLES below provide non-limiting embodiments of transition-metals doped Li-rich anti-perovskite compositions provided herein. For these EXAMPLES, analytical pure (AR) powders of LiCl, LiBr, LiI, LiNO₃, LiH, LiOH, Li₂O, CoO, NiO, FeO, CrBr₂ and Li metal were obtained from Alfa Aesar and/or Sigma.

### EXAMPLE A

Preparation of Li_{2.4}Co_{0.3}OBr: 0.241 g Li₂O, 0.259 g CoO and 1 g LiBr were weighted and ground together in a glovebox with oxygen<5 ppm and H₂O<5 ppm and under protection of Ar gas for several minutes. The resulting fine powder was placed in an alumina crucible and sintered in a muffle furnace. The sample was firstly heated to 450° C. at a heating rate of 20° C./min, then to 480° C. at a heating rate of 3° C./min. After holding at the highest reacting temperature for 5 hours, the samples were cooled to room temperature naturally. Phase-pure powders of Li_{2.4}Co_{0.3}OBr were obtained by repeating the grinding and heating processes for 2 times. The overall synthesis approach of a batch of samples required about 24 hours.

Powder X-ray diffraction data were collected at room temperature (25° C.) on a Bruker-AXS/D8 ADVANCE diffractometer using a rotating anode (Cu Kα, 40 kV and 40 mA), a graphite monochromator and a scintillation detector. Before measurements, the samples were enclosed in a sealed sample holder under Ar atmosphere to avoid moisture absorption. An X-ray diffraction pattern of the reaction product was dominated by the anti-perovskite Li_{2.4}Co_{0.3}OBr. While in some cases, additional and weaker diffraction lines also appeared that matched those for the unreacted raw materials Li₂O, LiBr or CoO (<5% by molar ratio). Usually, impurities can be avoided simply by repeat the grinding and heating processes.

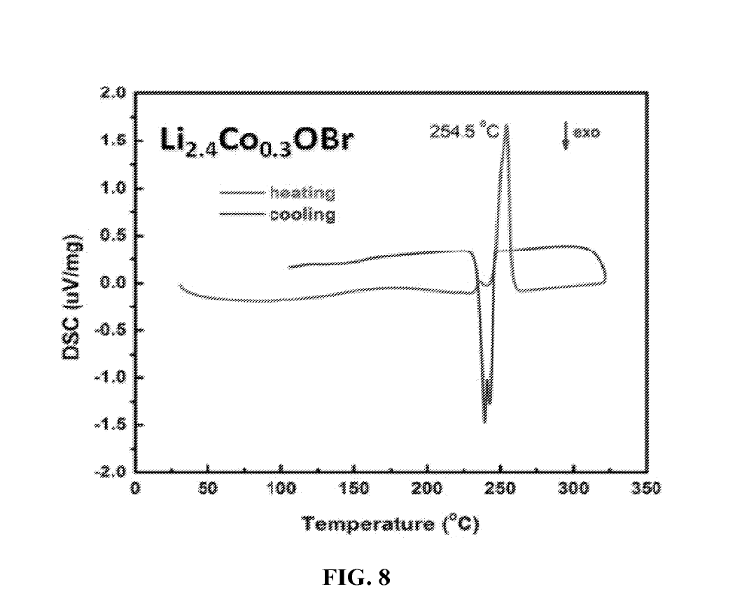

The thermal property of Li_{2.4}Co_{0.3}OBr was measured on a Netzsch STA 449 C. Samples were placed in alumina crucibles with lids inside a glovebox. Ar was used as a carrier gas during each test. TG-DSC measurements were recorded with heating/cooling rate of 10 K/min. As revealed by the differential scanning calorimetry (DSC) data in FIG. 8, the melting temperature of Li_{2.4}Co_{0.3}OBr is 254.5° C.

The lithium ionic conductivity of the product Li_{2.4}Co_{0.3}OBr was obtained from electrochemical impedance measurements. The samples were melted within two gold foils (thickness: 100 μm) at about 380° C. in inert atmosphere, and followed by prolonged annealing at 300° C. to ensure sufficient contacting. The as-obtained pellets had a final diameter of 10 mm and thickness of about 0.3 mm. AC impedance measurements were then performed using an electrochemical work station analyzer (Autolab) at frequencies ranging from 0.1 Hz to 10 MHz and a disturbance voltage of 5 mV. Since the materials are sensitive to moisture and become unstable with oxygen at elevated temperature, all of the measurements were made in dry Ar atmosphere. The ionic conductivity of Li_{2.4}Co_{0.3}OBr was approximately 10⁻⁶ S/cm at room temperature and increased to 10⁻⁴ S/cm when temperature higher than 80° C.

Compared with direct solid state reaction method (Li₂O+CoO+LiBr→Li_{2.4}Co_{0.3}OBr), excess Li metal (5%-10%) used in this procedure can eliminate the presence of OH⁻ in the lattice effectively and therefore the influence on sodium ionic conductivity. The overall reaction equation is listed as follows: 10Li+4Li(OH)+3Co(OH)₂+10LiX→10Li_{2.4}Co_{0.3}OX+5H₂↑.

### EXAMPLE B

Preparation of Li_{1.6}Cr_{0.7}OBr: 0.226 g Li₂O, 1 g CrBr₂, and 0.128 g CrO were weighted and ground together in an Ar atmosphere protected glovebox for several minutes. The resulting fine powder was placed in an alumina crucible then put into the furnace in the same glovebox with oxygen<5 ppm and H₂O<5 ppm. The sample was firstly heated to 350° C. at a heating rate of 10° C./min and then to 550° C. at a heating rate of 3° C./min. After holding at the highest reacting temperature for 8 hours, the samples were cooled to room temperature naturally. Phase-pure powders of Li_{1.6}Cr_{0.7}OBr were obtained by repeating the grinding and heating processes for 3 times. The overall synthesis approach of a batch of samples was about 30 hours.

Powder X-ray diffraction data were collected at room temperature (25° C.). Before measurements, the samples were enclosed in sealed sample holder under Ar atmosphere to avoid moisture absorption. An X-ray diffraction pattern of the reaction product was dominated by the anti-perovskite Li_{1.6}Cr_{0.7}OBr. The lithium ionic conductivity of the product Li_{1.6}Cr_{0.7}OBr was obtained from electrochemical impedance measurements. The samples were melted within two gold foils (thickness: 100 μm) at about 480° C. in inert atmosphere, and followed by prolonged annealing at 330° C. to ensure sufficient contacting. The as-obtained pellets had a final diameter of ˜7 mm and thickness of about 0.3 mm. AC impedance measurements were then performed using an electrochemical work station analyzer (Solartron/SI-1260/impedance and grain-phase Analyzer) at frequencies ranging from 0.1 Hz to 4 MHz and a disturbance voltage of 5 mV. The ionic conductivity of Li_{1.6}Cr_{0.7}OBr was approximately 10^{-5.5} S/cm at room temperature, and increased to 10⁻⁴ S/cm as the temperature increased above 80° C.

### EXAMPLE C

Preparation of Li_{1.5}Ni_{0.75}OBr_{0.5}Cl_{0 5}: 0.205 g Li₂O, 0.5 g NiBr₂, 0.296 g NiCl₂ and 0.171 g NiO were weighted and ground together in an Ar atmosphere protected glovebox for several minutes. The resulting fine powder was placed in an alumina crucible and then placed in the furnace within the same glovebox. The sample was firstly heated to 350° C. at a heating rate of 1.5° C./min, then to 450° C. at a heating rate of 10° C./min. After holding at the highest reacting temperature for 6 hours, the samples were cooled to room temperature naturally. Phase-pure powders of Li_{1.5}Ni_{0.75}OBr_{0.5}Cl_{0.5} were obtained by repeating the grinding and heating processes for 3 times. The overall synthesis approach of a batch of samples took about 24 hours.

Powder X-ray diffraction data were collected at room temperature (25° C.). Before measurements, the samples were enclosed in sealed sample holder under Ar atmosphere to avoid moisture absorption. An X-ray diffraction pattern of the reaction product was dominated by the anti-perovskite Li_{1.5}Ni_{0.75}OBr_{0.5}Cl_{0.5}. The lithium ionic conductivity of the product Li_{1.5}Ni_{0.75}OBr_{0.5}Cl_{0.5} was obtained from electrochemical impedance measurements. The samples were melted within two gold foils (thickness: 100 μm) at about 380° C. in inert atmosphere, and followed by prolonged annealing at 230° C. to ensure sufficient contacting. The as-obtained pellets had a final diameter of 7 mm and thickness of about 0.3 mm. AC impedance measurements were then performed using an electrochemical work station analyzer (Solartron/SI-1260/impedance and grain-phase Analyzer) at frequencies ranging from 0.1 Hz to 10 MHz and a disturbance voltage of 5 mV. The ionic conductivity of Li_{1.5}Ni_{0.75}OBr_{0.5}Cl_{0.5} was approximately 10^{-5.6} S/cm at room temperature, and increased to 10⁻⁴ S/cm as the temperature increased above 100° C.

### EXAMPLE D

Preparation of Li₂Fe_{0.5}OBr—Li₅FeO₂Br₃: 0.115 g Li₂O, 0.276 g FeO and 1 g LiBr (20% mole excess amount is added as the high annealing temperature) were weighted in a glovebox and ball-milled together in Ar atmosphere protected WC sealed container for 1 hour. The resulting fine powder was placed in an alumina crucible and put into the furnace in the glovebox with oxygen<5 ppm and H₂O<5 ppm and under protection of Ar gas. The sample was heated to 450° C. at a heating rate of 10° C./min and then heated to 580° C. at a heating rate of 3° C./min. After holding at the highest reacting temperature for 16 hours, the samples were cooled to room temperature naturally. Phase-pure powders of Li₂Fe_{0.5}OBr—Li₅FeO₂Br₃ were obtained by repeating the grinding and heating processes for 4-8 times with different cubic and layered anti-perovskite mole ratio. The overall synthesis approach of a batch of samples took about 130 hours.

Powder X-ray diffraction data were collected at room temperature (25° C.) on Bruker-AXS/D8 ADVANCE diffractometer using a rotating anode (Cu Kα, 40 kV and 40 mA. Before measurements, the samples were enclosed in a sealed sample holder under Ar atmosphere to avoid moisture absorption. An X-ray diffraction pattern of the reaction product was dominated by the anti-perovskite with cubic (Pm-3m) and layered (I4/mmm) crystal structures. Usually, impurities can be avoided simply by repeating the grinding and heating processes.

The lithium ionic conductivity of the product Li₂Fe_{0.5}OBr—Li₅FeO₂Br₃ was obtained from electrochemical impedance measurements. The samples were melted within two gold foils (thickness: 100 μm) at about 5000° C. in inert atmosphere, and followed by prolonged annealing at 430° C. to ensure sufficient contacting. The as-obtained pellets had a final diameter of 7 mm and thickness of about 0.3 mm. AC impedance measurements were then performed using an electrochemical work station analyzer (Solartron/SI-1260/impedance and grain-phase Analyzer) at frequencies ranging from 0.1 Hz to 10 MHz and a disturbance voltage of 5 mV. Since the materials are sensitive to moisture and become unstable with oxygen at elevated temperature, all of the measurements were made in dry Ar atmosphere. The ionic conductivity of Li_{1.5}Ni_{0.75}OBr_{0.5}Cl_{0.5} was approximately 10^{-4.6} S/cm at room temperature, and increased to 10⁻³ S/cm as the temperature increased above 150° C.

### EXAMPLE E

Preparation of LiNiONO₂: 0.333 g LiNO₃, 0.298 g Ni (5% excess weight was added for the weight loss during the annealing process) were weighted and ground together in an Ar atmosphere protected glovebox for several minutes. The resulting fine powder was placed in an alumina crucible and put in the furnace the glovebox with oxygen<5 ppm and H₂O<5 ppm and under protection of Ar gas. The sample was heated to 330° C. at a heating rate of 10° C./min and then to 380° C. at a heating rate of 2° C./min. After holding at the highest reacting temperature for 3 hours, the samples were cooled to room temperature naturally. Phase-pure powders of LiNiONO₂ were obtained by repeating the grinding and heating processes for 2 times. The overall synthesis approach of a batch of samples took about 10 hours.

Powder X-ray diffraction data were collected at room temperature (25° C.). Before measurements, the samples were enclosed in enclosed in a sealed sample holder under Ar atmosphere to avoid moisture absorption. An X-ray diffraction pattern of the reaction product was dominated by the anti-perovskite LiNiONO₂. The lithium ionic conductivity of the product LiNiONO₂ was obtained from electrochemical impedance measurements. The samples were melted within two gold foils (thickness: 100 μm) at about 350° C. in inert atmosphere, and followed by prolonged annealing at 280° C. to ensure sufficient contacting. The as-obtained pellets had a final diameter of 7 mm and thickness of about 0.3 mm. AC impedance measurements were then performed using an electrochemical work station analyzer (Solartron/SI-1260/impedance and grain-phase Analyzer) at frequencies ranging from 0.1 Hz to 10 MHz and a disturbance voltage of 5 mV. The ionic conductivity of LiNiONO₂ was approximately 10^{-5.2} S/cm and room temperature, and increased to 2×10⁻³ S/cm as the temperature increased above 100° C.

### EXAMPLE F

Preparation of full solid-state battery Li_{1.5}Ni_{0.75}OBr_{0.5}Cl_{0.5}∥Li₃OBr_{0.5}Cl_{0.5}∥Li-Metal: In a an Ar protected glovebox, a pellet of Li_{1.5}Ni_{0.75}OBr_{0.5}Cl_{0.5} with diameter of 10 mm and thickness of 2 mm were put in a gold cap; on top of the Li_{1.5}Ni_{0.75}OBr_{0.5}Cl_{0.5} pellet, a same diameter Li₃OBr_{0.5}Cl_{0.5} pellet with 1 mm thickness was added. Then all of them were put into the furnace within the glovebox and heated to 400° C. at a heating rate of 10° C./min. After holding at the highest reacting temperature for half hour, the whole assembly was cooled to room temperature naturally. Then a piece of lithium with thickness of 1 mm and diameter of 3 mm was put on the top surface of Li₃OBr_{0.5}Cl_{0.5}, then all together, the whole assembly was put back again into the furnace and heated to 185° C. at a heating rate of 3° C./min. After holding at the highest reacting temperature for 10 mins, the assembly was moved out of the furnace and the melted lithium was pressed by a steel cylinder to a flat shape attached on the Li₃OBr_{0.5}Cl_{0.5} surface, then the whole assembly was cooled to room temperature naturally. Then the assembled Au∥Li_{1.5}Ni_{0.75}OBr_{0.5}Cl_{0.5}∥Li₃OBr_{0.5}Cl_{0.5}∥Li-Metal battery was put in an electronic test cell with Cu wire as leads on both Au and Li sides, then the cell was sealed in Ar atmosphere.

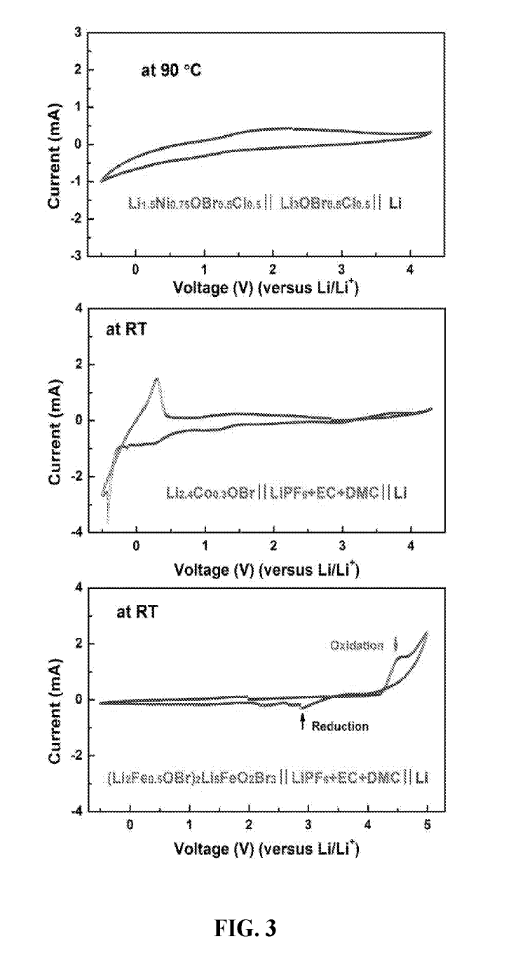

CV test (FIG. 3, top) of solid-state battery Li_{1.5}Ni_{0.75}OBr_{0.5}Cl_{0.5}∥Li₃OBr_{0.5}Cl_{0.5}∥Li-Metal was collected at 90° C. in a tube furnace (MTI/GSL1100X) under the protection of Ar gas. Before measurements, the battery was open circuit for several hours for balance. The open circuit voltage was about 2.5 V. The CV test was performed with Autolab/Potentiostat-galvanostat station with voltage up to 4.3 V and down to −0.5 V using Li⁺/Li as a reference. The scanning voltage step was 5 mV/s and cycling up to ten times. The results show Li_{1.5}Ni_{0.75}OBr_{0.5}Cl_{0.5} can work in the voltage range of 0 to 4.3 V.

Charging and discharging performance of solid-state battery Li_{1.5}Ni_{0.75}OBr_{0.5}Cl_{0.5}∥Li₃OBr_{0.5}Cl_{0.5}∥Li-Metal were characterized at 90° C. in a tube furnace (MTI/GSL1100X) under the protection of Ar gas. Before measurements, the battery was open circuit for several hours for balance. The charging current was set at 0.5 mA of the MTI/8-Channels-Battery-Analyzer. The charging plateau was at 4 V for the first cycle and gradually decays to 2 V for more cycles. The fluctuations of the charging/discharging curves are mainly from the interface contacts between Li_{1.5}Ni_{0.75}OBr_{0.5}Cl_{0.5} and Li₃OBr_{0.5}Cl_{0.5}, and between Li₃OBr_{0.5}Cl_{0.5} and Li metal.

### EXAMPLE G

Preparation of Li_{2.4}Co_{0.3}OBr∥LiPF₆+EC+DMC∥Li-Metal batteries: 0.8 g of pure Li_{2.4}Co_{0.3}OBr, 0.1 g carbon black, and 0.1 g PVDF were mixed together for several minutes in a glovebox with oxygen<5 ppm and H₂O<5 ppm and under the protection of Ar gas. Several drops of NMP solvent was added into the resulting fine powder to make a paste-like cathode compound. The agglutinating powder was pasted on one side of steel gasket for coin cell assembling. A piece of lithium metal in diameter of 7 mm and thickness 1 mm was used as the anode. The lithium metal was placed into the bottom cap of the coin cell, and then a polymer separator (CELGARD) with diameter of 11/16 inch was added on the top. Several drops of liquid electrolyte (LiPF₆+EC+DMC) were added to infiltrate the separator and the electrode active materials. The pasted steel gasket with the pasted side facing down was added on top of the separator, and a steel spring was added on the top of the steel gasket. Finally, the top cap of the coin cell was put on all the assembled bottom parts and the coin cell was pressed sealed by a crimping machine (MTI/190 for CR2032 coin cell). The assembled coin cell was put in the glovebox for several hours to equilibrate the battery.

CV tests (FIG. 3, middle) of Li_{2.4}Co_{0.3}OBr∥LiPF₆+EC+DMC Li-Metal batteries were collected at room temperature (25° C.) in a tube furnace (MTI/GSL1100X) under the protection of Ar gas. Before measurements, the battery was open circuit for several hours for balance. The open circuit voltage was about 2.0 V. The CV test was performed with Autolab/Potentiostat-galvanostat station with voltage up to 4.3 V and down to −0.5 V using Li⁺/Li as a reference. The scanning voltage step was 10 mV/s and cycling up to 20 times. The results show Li_{2.4}Co_{0.3}OBr can work in the voltage range of 0 to 4.3 V.

Charging and discharging performance of Li_{2.4}Co_{0.3}OBr∥LiPF₆+EC+DMC∥Li-Metal batteries at room temperature (25° C.) in a tube furnace (MTI/GSL1100X) under the protection of Ar gas. Before measurements, the battery was open circuit for several hours for balance. The charging current was set at 0.5 mA of the MTI/8-Channels-Battery-Analyzer. The charging plateau was at 3.5 V for the first cycle and gradually increases to 4.7 V for the rest several cycles. The discharging plateau was at ˜1.5 V.

### EXAMPLE H

Preparation of (Li₂Fe_{0.5}OBr)₂Li₅FeO₂Br₃∥LiPF₆+EC+DMC Li-Metal batteries: 0.8 g of pure (Li₂Fe_{0.5}OBr)₂Li₅FeO₂Br₃, 0.1 g carbon black, and 0.1 g PVDF were mixed together for several minutes in a glovebox with oxygen<5 ppm and H₂O<5 ppm and under the protection of Ar gas. Several drops of NMP solvent was added into the resulting fine powder to make a paste-like cathode compound. The agglutinating powder was pasted on one side of steel gasket for coin cell assembling. A piece of lithium metal in diameter of 7 mm and thickness 1 mm was used as the anode. The lithium metal was placed into the bottom cap of the coin cell, and then a polymer separator (CELGARD) with diameter of 11/16 inch was added on the top. Several drops of liquid electrolyte (LiPF₆+EC+DMC) were added to infiltrate the separator and the electrode active materials. The pasted steel gasket with the pasted side facing down was added on top of the separator, and a steel spring was added on the top of the steel gasket. Finally, the top cap of the coin cell was put on all the assembled bottom parts and the coin cell was pressed sealed by a crimping machine (MTI/190 for CR2032 coin cell). The assembled coin cell was put in the glovebox for several hours for the purpose of equilibration of the battery.

CV tests (FIG. 3, bottom) of (Li₂Fe_{0.5}OBr)₂Li₅FeO₂Br₃∥LiPF₆+EC+DMC∥Li-Metal batteries were collected at room temperature (25° C.) in a tube furnace (MTI/GSL1100X) under the protection of Ar gas. Before measurements, the battery was open circuit for several hours for balance. The open circuit voltage was about 2.6 V. The CV test was performed with Autolab/Potentiostat-galvanostat station with voltage up to 5.0 V and down to −0.5 V using Li⁺/Li as a reference. The scanning voltage step was 10 mV/s and cycling up to 20 times. The results show (Li₂Fe_{0.5}OBr)₂Li₅FeO₂Br₃∥LiPF₆+EC+DMC∥Li-Metal can work in the voltage range of 0 to 5.0 V. Further increase of the upper limit of the testing voltage will decompose the liquid electrolyte (LiPF₆+EC+DMC).

Charging and discharging of (Li₂Fe_{0.5}OBr)₂Li₅FeO₂Br₃∥LiPF₆+EC+DMC∥Li-Metal batteries at room temperature (25° C.) in a tube furnace (MTI/GSL1100X) under the protection of Ar gas. Before measurements, the battery was open circuit for several hours for balance. The charging current was set at 0.5 mA of the MTI/8-Channels-Battery-Analyzer. The charging plateau was at 3.2 V for the first several cycles and gradually increases to 4.5 V for up to 20 cycles. The discharging plateau was at 1.5 V.

### EXAMPLE I

Preparation of Li_{2.4}Co_{0.3}S(NO₂) by using a high-pressure and high-temperature method: An amount of 0.460 grams Li₂S, amount of 0.212 grams of LiNO₂, and amount of 0.453 grams of Co(NO₂)₂, which corresponds to a molar ratio of Li₂S:LiNO₂:Co(NO₂)₂ of 1:0.4:0.3, were mixed and grinded in a glove box under a dry argon atmosphere. The powder was then enclosed inside a container with its cap sealed using high-performance SCOTCH TAPE®. The syntheses was monitored by in-situ and real-time synchrotron X-ray diffraction using a PE apparatus at Beamline 16-BMB of the Advanced Photon Source (APS) at Argonne National Laboratory. The powder was loaded into a high pressure cell that consisted of an MgO container of 1 millimeter inner diameter and 1 millimeter length also serving as the pressure scale and a graphite cylinder as a heating element. Then two MgO disks were used to seal the sample from interacting with the outside environments (e.g., the oxygen and moisture).

After the pressure cell was completely assembled, all air pathways on the pressure cell were covered by DUCO® cement to isolate the powders from moisture. Before removing the assembly from the glove box, the resulting as-finished pressure cell was placed into a capped plastic tube with both ends sealed by high-performance electrical tape. The pressure cell was removed from the plastic tube, placed into the PE cell, and rapidly pumped up to a pressure of about 0.5 GPa sample pressure. Typically, it took 2-5 minutes to set up the anvil pressure module into the hydraulic press and then pump the oil pressure up so as to reach a sample pressure condition of approximately 0.5 GPa. It was believed that these steps isolated the sample contents of the pressure cell from room air. After synchrotron X-ray diffraction data were collected at two different sample positions, the sample were compressed to higher pressure and then heated in a stepwise fashion from a temperature of 100° C. to 800° C. Synchrotron X-ray diffraction data were collected for both the sample and the MgO along the heating path at temperatures of 100° C., 200° C., 300° C., 400° C., 500° C., 550° C., 600° C., 650° C., 700° C., 750° C. and 800° C. The experiment was ended by cooling to room temperature and then decompression to ambient conditions. Afterward, diffraction data were collected on the recovered sample at two different sample conditions.

### EXAMPLE J

Preparation of Li_{2.4}Co_{0.3}OBr in lamellar single crystal form: 0.241 g Li₂O, 0.259 g CoO and 1 g LiBr were weighted and ground together in a glovebox under protection of Ar atmosphere for several minutes. The resulting fine powder was placed in an alumina crucible. The sample was firstly heated to 450° C. at a heating rate of 10° C./min then to 480° C. at a heating rate of 3° C./min. After holding at the highest reacting temperature for 5 hours, the samples were cooled to room temperature naturally. Phase-pure powders of Li_{2.4}Co_{0.3}OBr were obtained by repeating the grinding and heating processes for 3 times. Then the powders were allowed to melt again and cooled to room temperature with a cooling rate of 3° C./hour. Lamellar single crystal of Na₃OCl (thickness 10-50 μm) were obtained by mechanical separation.

The lithium ionic conductivity of the Li_{2.4}Co_{0.3}OBr single crystal was obtained from electrochemical impedance measurements. The samples were coated with Au film on both sides in an inert atmosphere, and followed by annealing at 430° C. to ensure sufficient contacting. AC impedance measurements were then performed using an electrochemical work station analyzer (Solartron/SI-1260/impedance and grain-phase Analyzer) at frequencies ranging from 0.1 Hz to 4 MHz and a disturbance voltage of 5 mV.

### EXAMPLE K

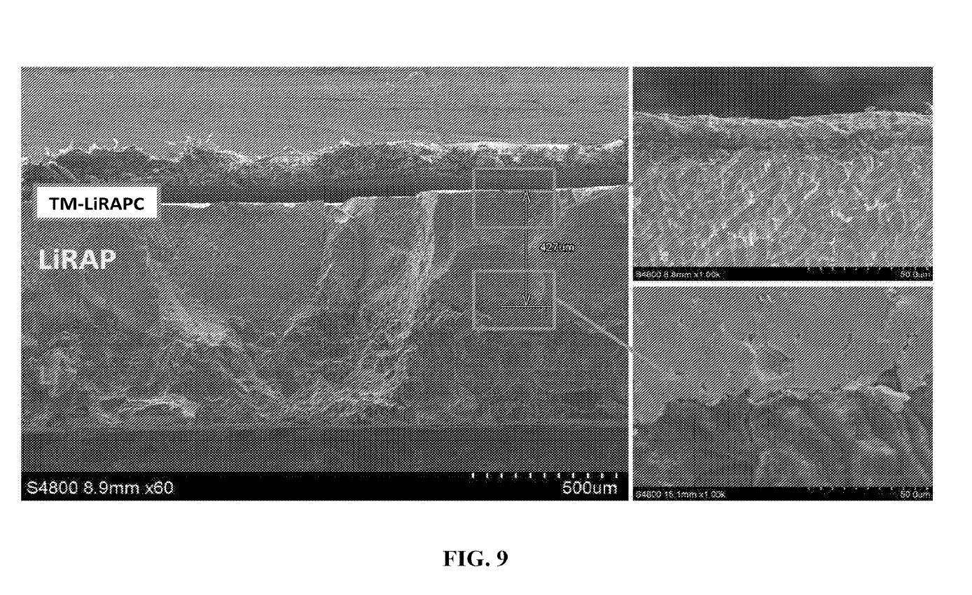

Characterization of a Li_{2.4}Co_{0.3}OBr∥Li₃OBr∥Li-metal solid state battery. The all-solid-state battery Li_{2.4}Co_{0.3}OB∥Li₃OBr∥Li-Metal was fabricated with hot pressing of Li-metal onto the co-synthesized bi-layer materials, and tested at elevated temperatures. The SEM images (FIG. 9) show the cross section of the solid state battery Li_{2.4}Co_{0.3}OBr∥Li3OBr∥Li-metal fabricated via hot press method, with dense layers and good contacted interface.

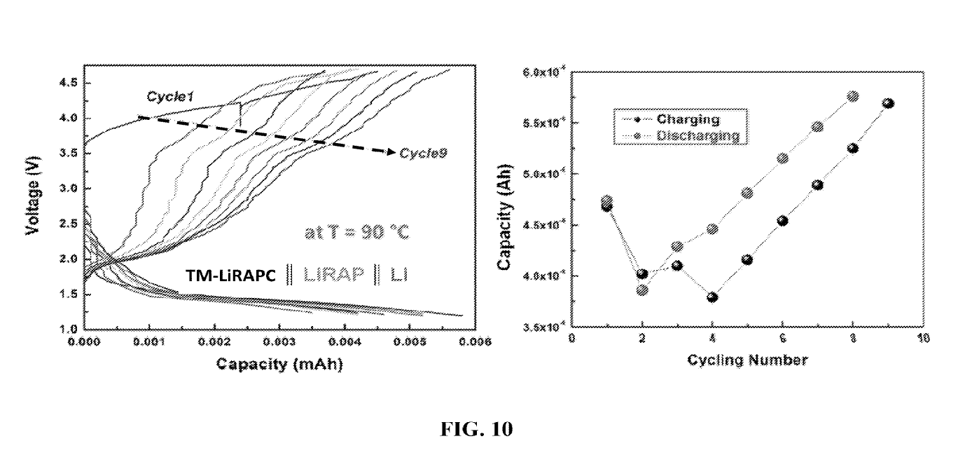

FIG. 10 shows battery charging/discharging curves at 90° C. The battery was charged to 4.6 V and discharged to 1.2 V. The battery was running for 9 cycles, with capacity increasing. This capacity increase is hypothesized to be due to the Li⁺ migration through enhanced channel interfaces. This indicates improved interface based on the similar structure cathode and electrolyte.

In a solid state battery, solid-solid interface is a critical issue, which has significant influence on battery performance. Here, the TM-LiRAP-C composition has a similar crystal structure and chemistry compared to the LiRAP electrolyte, and thus there will be no detrimental chemical reactions for the cathode/electrolyte coupling. The match in crystal lattices should lead to easy Li⁺ transporting across the crystalline interfaces between cathode and electrolyte with high cycling efficiency. This is a unique advantage of the LiRAP-based cathode/electrolyte coupling that both materials can be synthesized simultaneously to form the natural intergrowth layer of TM-LiRAP-C and LiRAP electrolyte. The continuous bi-layers deposition of TM-LiRAP-C and LiRAP at the interface allows significant structure tolerance for large quantity lithiation/delithiation coupled with superionic Li⁺ transporting in electrochemical optimizations. It can also reduce the interface stress/strain, thereby improving the battery life.

Additional Discussion

As explained elsewhere herein, lithium ion batteries show great promise in portable and mobile electronic devices with high energy and power densities, charge-discharge rates, and cycling lifetimes. However, common fluid electrolytes consisting of lithium salts dissolved in solvents can be toxic, corrosive, or even flammable. Presently, solid electrolyte candidates predominantly suffer from the solid-solid interface mismatch between the electrolyte and the cathode, thereby hindering Li⁺ transportation. TM-LiRAP-C can provide intergrowth with the anti-perovskite solid electrolyte, overcoming the aforementioned interface problems, and thus allowing for comparatively lower cost and higher safety devices.

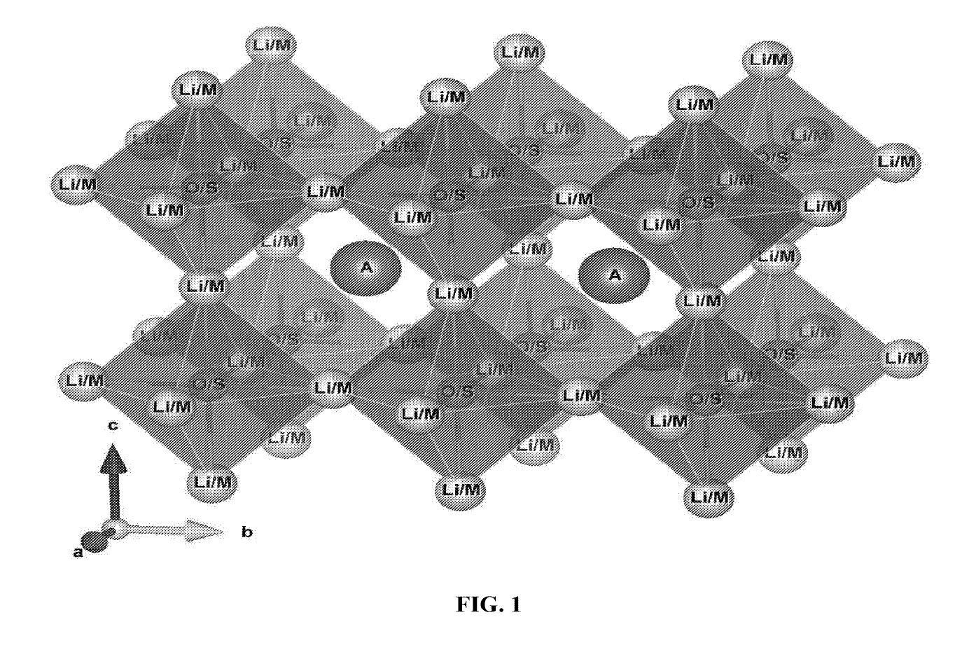

The present disclosure provides, inter alia, a new family of cathodes with three-dimensional conducting pathways based on transition-metals doped Li-rich anti-perovskites (FIG. 1). The materials can, in some cases, exhibit ionic conductivity of, e.g., σ>10⁻³ S/cm at moderate temperature (e.g., 100° C.) and an activation energy of about 0.6 eV; exhibit electronic conductivity of, e.g., ρ<10⁸ Ω/cm. Most importantly, the disclosed crystalline materials can be readily manipulated via chemical and structural methods to be fabricated with high-performance in full solid-state batteries in electrochemistry applications.

The present disclosure also provides a variety of synthesis techniques useful for synthesizing the disclosed materials. The solid state reaction is the most direct and convenient method to obtain TM-LiRAP-C composites. The equation can be:

7Li₂O+3CoO+10LiBr→10Li_{2.4}Co_{0.3}OBr

However, extreme care should be taken during the whole reaction period to avoid the presence of water or hydroxyl. While other synthetic methods adopting lithium metal, LiH or organic halides can avoid this problem easily. For example in the lithium metal reduction method, excess Li metal (5%-10%) is used to eliminate the presence of OH⁻ in the lattice and therefore its influence on conductivity. The starting materials of Li_{2.4}Co_{0.3}OBr synthesis can comprise combining (e.g., mixing) together 0.4 equivalent of LiOH, 0.3 equivalent of Co(OH)₂, 1 equivalent of LiBr and excess 1.1 equivalent of Li metal. In an exemplary synthesis, firstly, LiOH, Co(OH)₂, and LiBr are ground together for several minutes with a mortar and pestle. Then the resulting powder can be placed on the top of the Li metal and slowly heated to 210° C. (i.e., past the melting point Tₘ˜180.5° C. of Li metal) under vacuum or in a glovebox with oxygen<5 ppm, H₂O<5 ppm, and under protection of Ar gas, and finally heated quickly to about 450° C. for a period of time.

During heating, hydrogen is generated and evacuated outside. It can be considered as an in situ method to produce fresh Li₂O and CoO by the following equations:

Li+LiOH→Li₂O+1/2H₂↑

2Li+Co(OH)₂→Li₂O+CoO+H₂↑
And the overall reaction equation is listed as follows:

10Li+4Li(OH)+3Co(OH)₂+10LiBr→10Li_{2.4}Co_{0.3}OBr+5H₂↑

At the end of the reaction, the molten product in the furnace can be rapidly cooled (e.g., quenched) or slowly cooled to room temperature, which results in different textures and grain boundary morphologies.

Other reducers such as LiH can also be used to obtain Li_{(3-δ)}M_{δ/m}OA without hydroxyl. The impact of them to eliminate hydroxyl follows the equation:

LiH+LiOH→Li₂O+H₂↑

mLi+M(OH)ₘ→m/2 Li₂O+MO_{m/2}+m/2 H₂↑

And the overall reaction equation is listed as follows:

LiH+(1−δ) LiOH+δ/m M(OH)ₘ+LiA→Li_{(3-δ)}M_{δ/m}OA+H₂↑(δ<1)

Sometimes, there are several intermediate phases [e.g. Li_{(2-δ)}M_{δ/m}(OH)X] observed during the reaction process. Then LiH reacts with the intermediate phases to give the final anti-perovskite products. In such a two-step process, the reaction equations are:

(1−δ) LiOH+δ/m MO_{m/2}+LiA→Li_{(2-δ)}M_{δ/m}(OH)A (δ<1)

Li_{(2-δ)}M_{δ/m}(OH)A+LiH→Li_{(3-δ)}M_{δ/m}OA+H₂↑

A two-step reaction process can be helpful for the achievement of pure anti-perovskite products. Without being bound by a particular theory, it is hypothesized that the advantage of the two-step method is that the intermediate phase Li_{(2-δ)}M_{δ/m}(OH)A also adopts similar anti-perovskite structure with the final products.

At the end of the reaction, the molten product in the furnace can be rapidly cooled (e.g., quenched) or slowly cooled to room temperature.

More TM-LiRAP-C composites (e.g., LiFeSCl, Li_{1.5}V_{0.75}OCl_{0.5}Br_{0.5}, Li_{2.2}Ni_{0.3}Mn_{0.1}OBr_{0.5}I_{0.5}) can be synthesized by replacing any of the components in Li_{2.4}Co_{0.3}OBr using the same or similar sintering method. Some respective equations are listed as follows:

LiFeSCl: Li₂S+FeS+FeCl₂→2LiFeSCl

Li_{1.5}V_{0.75}OCl_{0.5}Br_{0.5}: 0.25Li₂O+0.75VO+0.5LiCl+0.5LiBr→Li_{1.5}V_{0.75}OCl_{0.5}Br_{0.5}

or 0.75Li+0.75LiOH+0.25VO+0.25VCl₂+0.25VBr₂→Li_{1.5}V_{0.75}OCl_{0.5}Br_{0.5}+0.375H₂↑

or 0.5Li₂O+0.5VO+0.25VCl₂+0.5LiBr→Li_{1.5}V_{0.75}OCl_{0.5}Br_{0.5}

Li_{2.2}Ni_{0.3}Mn_{0.1}OBr_{0.5}I_{0.5}:0.6Li₂O+0.3NiO+0.1MnO+0.5LiBr+0.5LiI→Li_{2.2}Ni_{0.3}Mn_{0.1}OBr_{0.5}I_{0.5}

or 0.6Li+0.3NiO+0.1MnO+0.6LiOH+0.5LiBr+0.5LiI→Li_{2.2}Ni_{0.3}Mn_{0.1}OBr_{0.5}I_{0.5}

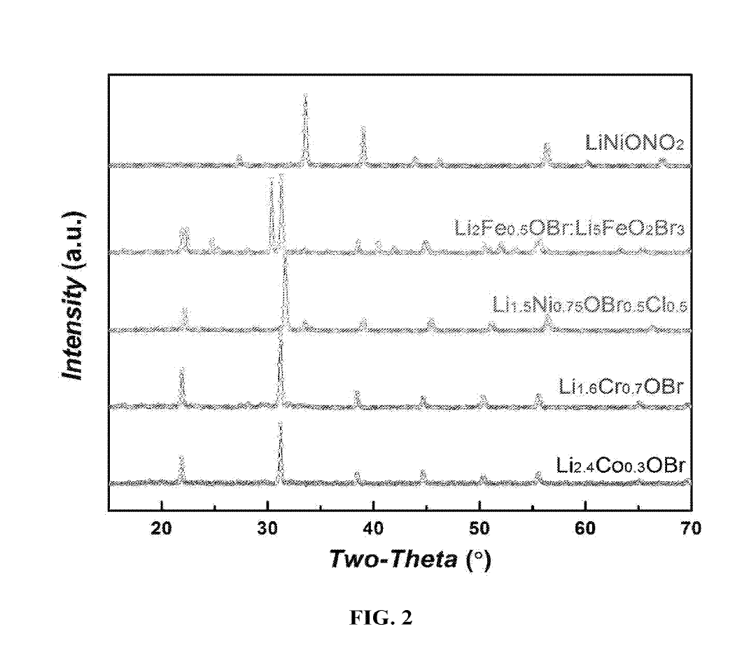

FIG. 2 shows the powder X-ray diffraction pattern of the TM-LiRAP-C composites. The products by halides-mixing and higher-valent-metal-dopping could be readily obtained with high purity and the main peaks could be indexed in cubic space group Pm-3m of the antiperovskite structure. One can combine the above-mentioned reactions to produce materials with more anti-perovskite compositions.

The TM-LiRAP-C compositions can, in some cases, be hygroscopic and they can be advantageous to prevent their exposure to atmospheric moisture. Exemplary synthesis, material handling, and all subsequent measurements can be performed in dry glove boxes with controlled dry inert atmosphere (Ar or N₂).

The TM-LiRAP-C materials can cycle the melting and crystallization processes several times without decomposition, showing their potential facility for hot machining.

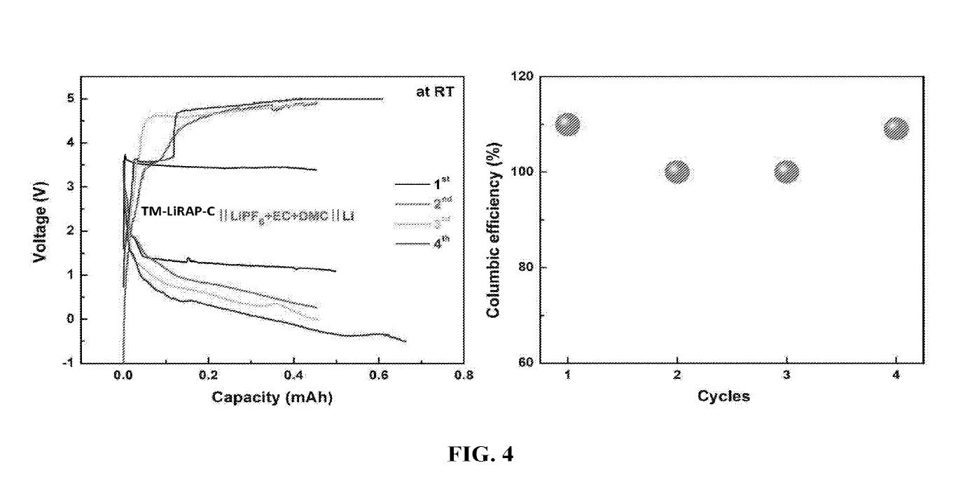

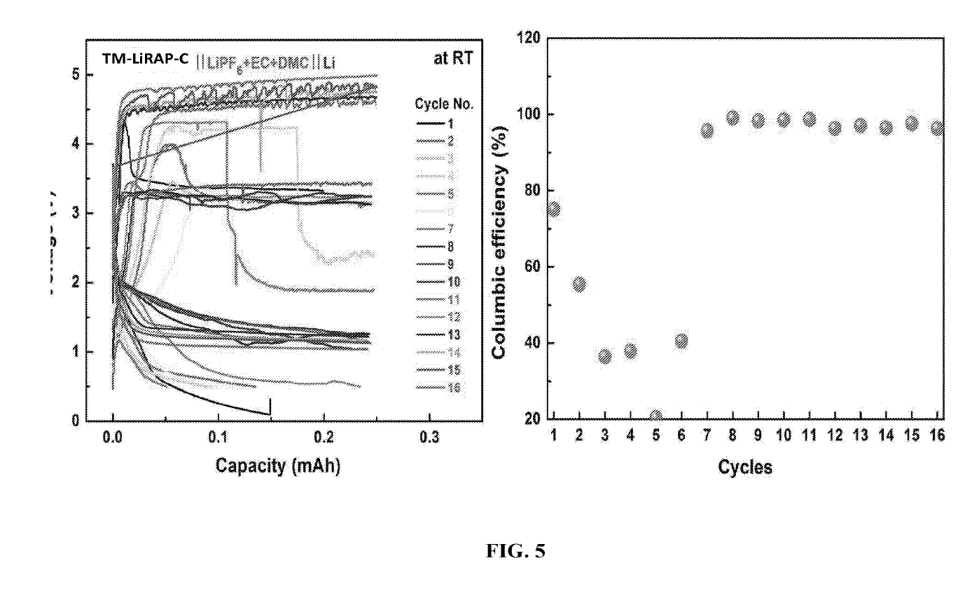

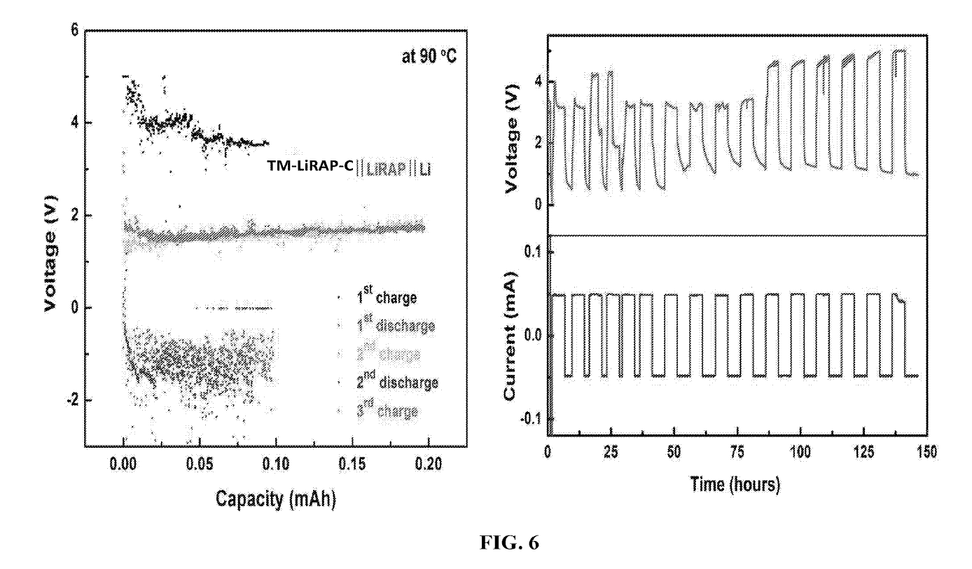

Transition-metals doped Li-rich anti-perovskite composites serving as promising cathodes can greatly benefit from their flexible crystal structures for easy chemical manipulation. FIGS. 4 and 5 show the charging/discharging measurement for Li_{2.4}Co_{0.3}OBr∥LiPF₆+EC+DMC∥Li and Li_{2.4}Ni_{0.3}0NO₂∥LiPF₆+EC+DMC∥Li-Metal, respectively. The charging platform was at ˜3.2 V and discharging to ˜1 V. The battery with Co-doped LiRAP-C was cycled for 4 times. The battery with Ni-doped LiRAP-C is very stable after charging and discharging for more than 10 cycles. Further, the full solid-state battery using anti-perovskite cathodes and anti-perovskite electrolytes have a well contacted interface and decreased interfacial mismatch, and thus having the advantage of enhanced battery performance and stability. FIG. 6 shows the representative charging/discharging measurement results for the Li_{2.4}Co_{0.3}OBr∥Li₃OBr∥Li at moderate temperatures, and voltage and current profile vs. time. The charging voltage for the first cycle is at ˜4 V, and discharging voltage for all the three cycles is at ˜1 V. The charging voltage for the second and third cycles changes to ˜2 V.

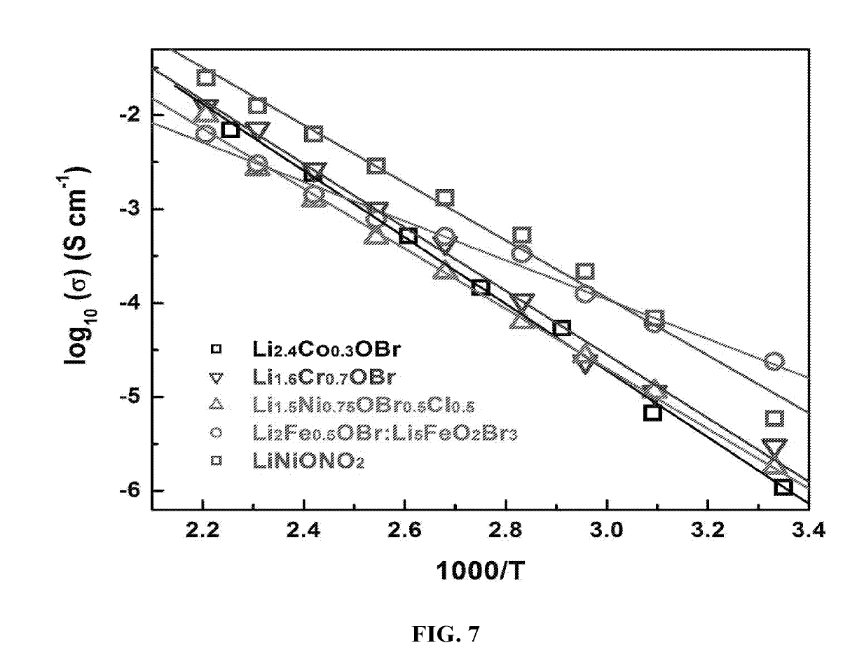

The lithium ion conductivity of Li_{2.4}Co_{0.3}OBr as a function of temperature is shown in FIG. 7 with a conductivity at 10⁻⁶ S/cm at room temperature. The activation energies for ionic conduction were calculated to be 0.6 eV for Li_{2.4}Co_{0.3}OBr based on the formula: σT=A₀×exp(−Eₐ/kT).

The impact of possible big anions (C1⁻, Br⁻, I⁻) in the B-sites. It is generally considered that small divalent O²⁻/S²⁻ will occupy the octahedrally coordinated B-sites in an anti-perovskite structure. However, it is also possible for bigger halide anions occupying the B-sites and accordingly the O²⁻/S²⁻ anions in the A-sites, especially when their radiuses are close. The event can happen as partially mixed static distribution or fully reversed A-/B-sites occupation. The lithium ionic conductivity can benefit from the easier migration of lithium ions due to the weaker bonding between them and the monovalent anions.

The disclosed transition-metals doped lithium-rich compositions based on the anti-perovskite offer a number of applications. For example, Li-rich anti-perovskites represent advances in electrochemistry systems as a cathode material that offers a variety of possible cation and/or anion manipulations. Indeed, the low melting point of the anti-perovskites enables the straightforward fabrication of thin films, which is useful in the fabrication of layered structures and components for high-performance battery/capacitor devices with existing technology. The anti-perovskites have a high lithium concentration, display superionic conductivity, and offer a comparatively large operation window in voltage and current. The products are lightweight and can be formed easily into sintered compacts. The disclosed anti-perovskites are readily decomposed by water to lithium hydroxide and lithium halides of low toxicity and are therefore completely recyclable and environmentally friendly. The low cost of the starting materials and easy synthesis of the products in large quantities present economic advantages as well. Additionally, the Li-rich anti-perovskites represent a material capable of structural manipulation and electronic tailoring.

Although the present invention has been described with reference to specific details, it is not intended that such details should be regarded as limitations upon the scope of the invention, except as and to the extent that they are included in the accompanying claims.

1. A cathode composition comprising a material having a formula of
(a) Li_{(3-δ)}M_{δ/2}BA,
wherein 0<δ≦2,
(b) Li_{(3-δ)}M_{δ/3}BA,
wherein 0<δ≦2.25,
(c) Li_{(3-δ)}M_{δ/4}BA,
wherein 0<δ≦2.4,
(d) Li_{(3-δ)}M_{δ/5}BA,
wherein 0<δ≦2.5,
(e) Li_{(3-δ)}M_{δ/6}BA,
wherein 0<δ≦2.57,
(f) Li_{(4-δ)}M_{δ/2}PO₄A,
wherein 0<δ≦2.67,
(g) Li_{(4-δ)}M_{δ/3}PO₄A,
wherein 0<δ≦3,
(h) Li_{(4-δ)}M_{δ/4}PO₄A,
wherein 0<δ≦3.2,
(i) Li_{(4-δ)}M_{δ/5}PO₄A,
wherein 0<δ≦3.33,
(j) Li_{(4-δ)}M_{δ/6}PO₄A,
wherein 0<δ≦3.43, or
a mixture thereof,
wherein M is a transition metal having a valence state of ⁺2, ⁺3, ⁺4, ⁺5, or ⁺6, which is denoted as M_{δ/valence},
B is a divalent ion, and
A is a monovalent ion.

2. The cathode composition of claim 1, wherein B is selected from the group consisting of O²⁻, S²⁻, SO₄²⁻, and a mixture thereof.

3. The cathode composition of claim 1, wherein A is selected from the group consisting of F⁻, Cl⁻, Br⁻, I⁻, H⁻, CN⁻, BF₄⁻, BH₄⁻, ClO₄⁻, CH₃⁻, NO₂⁻, NH₂⁻ and a mixture thereof.

4. The cathode composition of claim 1, wherein M is selected from the group consisting of iron, cobalt, nickel, manganese, titanium, vanadium, chromium, molybdenum and a mixture thereof.

5. An electrochemical device comprising the cathode composition of claim 1.

6. The electrochemical device of claim 5, wherein said electrochemical device comprises a battery or a capacitor.

7. The electrochemical device of claim 6, further comprising a lithium-rich solid electrolyte and a lithium-based anode.

8. The electrochemical device of claim 7, wherein the lithium-rich solid electrolyte is a lithium-rich anti-perovskite electrolyte.

9. A method of synthesizing the cathode composition of claim 1, wherein said method includes a synthesis method selected from the group consisting of direct solid state method, sodium metal reduction method, solution precursor method, and organic halide halogenation method.

10. A method of making the cathode composition of claim 1, comprising one or more processing methods selected from the group consisting of hot-spreading method, solution precursor method, and vacuum-splashing method.
